(19) United States
(12) Patent Application Publication
(10) Pub. No.: US 2009/0220120 A1
(43) Pub. Date: Sep. 3, 2009

(54) SYSTEM AND METHOD FOR ARTISTIC SCENE IMAGE DETECTION

(76) Inventors: Jonathan Yen, San Jose, CA (US); William C. Kress, Vista, CA (US); Harold Boll, Winchester, MA (US); Robert Poe, Encinitas, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/039,225

(22) Filed: Feb. 28, 2008

(51) Int. Cl. G06K 9/00

(52) U.S. Cl. 382/100

(57) ABSTRACT

The subject application is directed to a system and method for artistic scene image detection. First, image data is received that is encoded in a multi-dimensional color space. From the received image data, histogram data is then calculated. Dominant spike regions in the calculated histogram data are then identified. An N-sum value is then calculated from the identified dominant spike regions in the calculated histogram data. Testing of the calculated N-sum value against a predetermined threshold value then occurs. The received image data is thereafter classified as an artistic scene, a tinted artistic scene, or a sepia tone range artistic scene according to the testing results.

### BACKGROUND OF THE INVENTION

The subject application is directed generally to analysis or classification of encoded images and is particularly suited for detection of artistic scenes in electronic images.

Electronic images are created or captured in many ways, such as from digital still cameras, digital motion cameras, digital imaging software, or the like. Skilled photographers create artistic images that have properties specifically chosen for effect. Such effects may include unusual color balances, dominance of one or more hues, or use of limited color spectra. Earlier photographers obtained such effects by strategic placement of lighting, such as with a sunset, use of color filters on lenses, or by a particular environment such as with an underwater shooting. Such effects may also be accomplished with close-ups, sepia, higher speed or lower speed image capturing, diffusion filters, or mood lighting.

With digital images, computational enhancements are frequently made, such as white balancing, color adjustment, and the like. Application of such enhancements is not desirable when artistic images are deliberately created.

### SUMMARY OF THE INVENTION

In accordance with one embodiment of the subject application, there is provided a system and method for analysis or classification of encoded images.

Further in accordance with one embodiment of the subject application, there is provided a system and method for detection of artistic scenes in electronic images.

Still further in accordance with one embodiment of the subject application, there is provided a system for artistic scene image detection. The system comprises means adapted for receiving image data encoded in a multi-dimensional color space and means adapted for calculating histogram data from received image data. The system also comprises means adapted for identifying dominant spike regions in calculated histogram data and testing means for testing a calculated N-sum value against a predetermined threshold value. The system further comprises classifying means adapted for classifying received image data as at least one of an artistic scene, a tinted artistic scene, and a sepia tone range artistic scene in accordance with an output of the testing means.

In one embodiment of the subject application, the system further includes means adapted for identifying near achromatic pixels in received image data and means adapted for selectively discarding identified near achromatic pixels prior to calculation of histogram data therefrom.

In another embodiment of the subject application, the system also includes means adapted for receiving input image data and means adapted for converting received input image data into the image data encoded in HSV color space.

In a further embodiment of the subject application, the system also comprises means adapted for down-sizing image data prior to calculation of histogram data therefrom.

Still further, in accordance with one embodiment of the subject application, there is provided a method for artistic scene image detection in accordance with the system as set forth above.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject application is described with reference to certain figures, including:

FIG. 1 is an overall diagram of a system for artistic scene image detection according to one embodiment of the subject application;

FIG. 2 is a block diagram illustrating controller hardware for use in the system for artistic scene image detection according to one embodiment of the subject application;

FIG. 3 is a functional diagram illustrating the controller for use in the system for artistic scene image detection according to one embodiment of the subject application;

FIG. 4A is an example image for use with the system and method for artistic scene image detection according to one embodiment of the subject application;

FIG. 4B is an example image illustrating the artistic manipulation of the image of FIG. 4A for use with the system and method for artistic scene image detection according to one embodiment of the subject application;

FIG. 4C is an example image illustrating erroneous automatic image correction of the image of FIG. 4B for use with the system and method for artistic scene image detection according to one embodiment of the subject application;

FIG. 5A is an example artistic scene image for use with the system and method for artistic scene image detection according to one embodiment of the subject application;

FIG. 5B is a normalized histogram in hue corresponding to the image of FIG. 5A for use with the system and method for artistic scene image detection according to one embodiment of the subject application;

FIG. 6A illustrates a hue ramp for use in the system and method for artistic scene image detection according to one embodiment of the subject application;

FIG. 6B illustrates a partitioned hue ramp for use in the system and method for artistic scene image detection according to one embodiment of the subject application;

FIG. 7A is another example image for use with the system and method for artistic scene image detection according to one embodiment of the subject application;

FIG. 7B is a hue histogram in HSV corresponding to the image of FIG. 7A for use with the system and method for artistic scene image detection according to one embodiment of the subject application;

FIG. 7C is a de-noised hue histogram corresponding to the input image of FIG. 7A for use with the system and method for artistic scene image detection according to one embodiment of the subject application;

FIG. 7D is an illustration of the input image of FIG. 7A depicting the discarded pixels in accordance with the de-noising histogram of FIG. 7C for use with the system and method for artistic scene image detection according to one embodiment of the subject application;

FIG. 8A is an example artistic scene image for use in the system and method for artistic scene image detection according to one embodiment of the subject application;

FIG. 8B is a normalized histogram in hue corresponding to the image of FIG. 8A for use with the system and method for artistic scene image detection according to one embodiment of the subject application;

FIG. 9A is another example artistic scene image for use with the system and method for artistic scene image detection according to one embodiment of the subject application;

FIG. 9B is a normalized histogram in hue corresponding to the image of FIG. 9A for use with the system and method for artistic scene image detection according to one embodiment of the subject application;

FIG. 10A illustrates several artistic scene images for use with the system and method for artistic scene image detection according to one embodiment of the subject application;

FIG. 10B illustrates the images of FIG. 10A after erroneous automatic correction for use with the system and method for artistic scene image detection according to one embodiment of the subject application;

FIG. 11A illustrates plots of hue angles at a first spike for a plurality of input images in accordance with the system and method for artistic scene image detection according to one embodiment of the subject application;

FIG. 11B illustrates plots of hue angles at a second spike for a plurality of input images in accordance with the system and method for artistic scene image detection according to one embodiment of the subject application;

FIG. 11C illustrates plots of hue angles at a third spike for a plurality of input images in accordance with the system and method for artistic scene image detection according to one embodiment of the subject application;

FIG. 12A illustrates plots of combined 3-sums at first and second spikes in accordance with the system and method for artistic scene image detection according to one embodiment of the subject application;

FIG. 12B illustrates plots of combined 5-sums at first and second spikes in accordance with the system and method for artistic scene image detection according to one embodiment of the subject application;

FIG. 12C illustrates plots of combined 7-sums at first and second spikes in accordance with the system and method for artistic scene image detection according to one embodiment of the subject application;

FIG. 13 is an illustration of the relationship of various artistic image types in accordance with the system and method for artistic scene image detection according to one embodiment of the subject application;

FIG. 14 is a flowchart illustrating a method for artistic scene image detection according to one embodiment of the subject application; and

FIG. 15 is a flowchart illustrating a method for artistic scene image detection according to one embodiment of the subject application.

### DETAILED DESCRIPTION OF THE PREFERRED EMBODIMENT

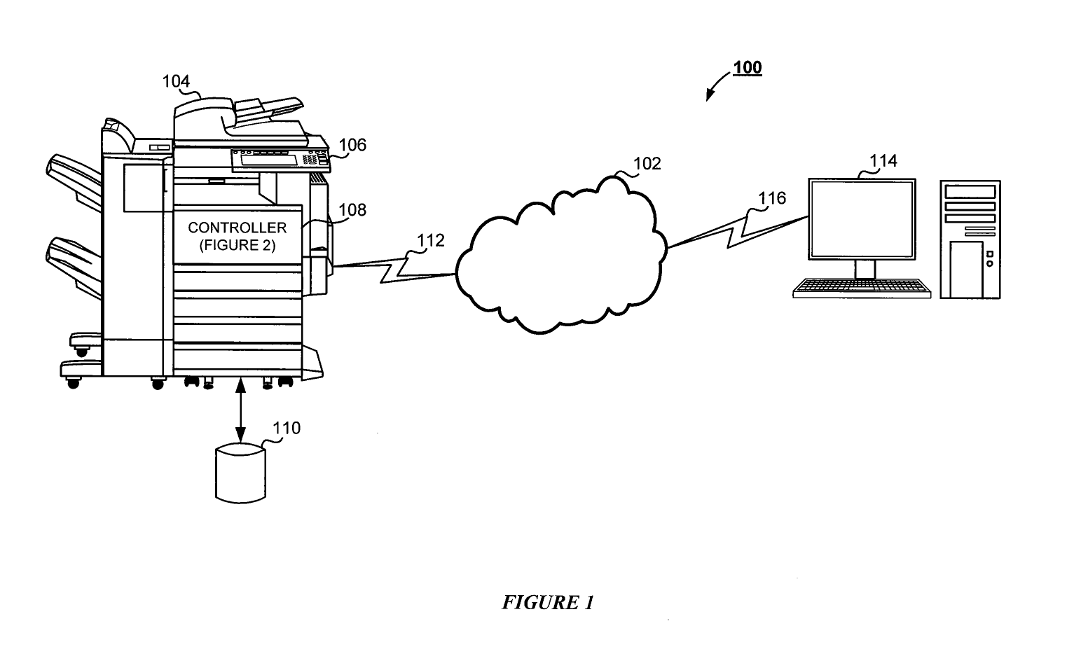

The subject application is directed to a system and method for analysis or classification of encoded images. In particular, the subject application is directed to a system and method for detection of artistic scenes in electronic images. It will become apparent to those skilled in the art that the system and method described herein are suitably adapted to a plurality of varying electronic fields employing electronic analysis including, for example and without limitation, communications, general computing, data processing, document processing, or the like. The preferred embodiment, as depicted in FIG. 1, illustrates a document processing field for example purposes only and is not a limitation of the subject application solely to such a field. The skilled artisan will appreciate that, as used herein, an artistic image or scene corresponds to an image created deliberately by a person knowledgeable in photography, e.g., image effects that would otherwise be problematic or unintentional, or would otherwise detract from the underlying image. Such examples, as will be understood by those skilled in the art, include, without limitation, unusual color balance, predominance of one or a small number of hues, lighter or darker than typical, unusual contrast, and the like.

Referring now to FIG. 1, there is shown an overall diagram of a system 100 for artistic scene image detection in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, depicted in FIG. 1 as a multifunction peripheral device suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user; receive input from the associated user; and communicate the same to a backend component such as a controller 108, as is explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

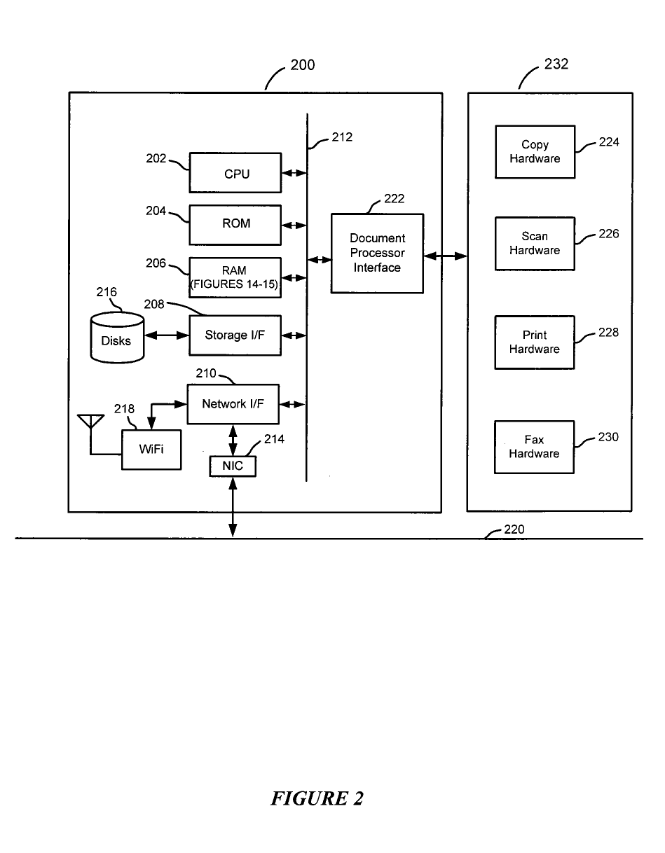

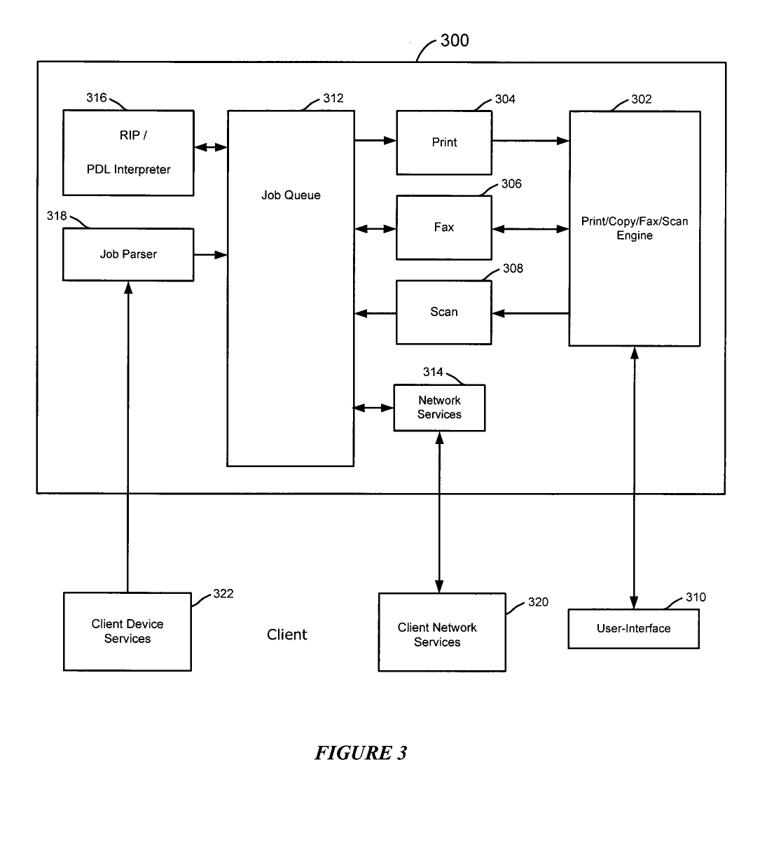

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for artistic scene image detection of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like.

The system 100 illustrated in FIG. 1 further depicts a user device 114 in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the user device 114 is suitably adapted to generate and transmit electronic images, document processing instructions, user interface modifications, upgrades, updates, personalization data, or the like to the document processing device 104 or any other similar device coupled to the computer network 102. In accordance with one embodiment of the subject application, the user device 114 is suitably adapted to perform image processing operations in accordance with the subject application.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device known in the art that is capable of facilitating the methodologies described herein. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions, such as BIOS functions, system functions, system configuration data, and other routines or data used for operation of the controller 200.

Also included in the controller 200 is random access memory 206 suitably formed of dynamic random access memory, static random access memory, or any other suitable, addressable, and writable memory system. Random access memory 206 provides a storage area for data instructions associated with applications and data handling accomplished by the processor 202.

A storage interface 208 suitably provides a mechanism for non-volatile, bulk, or long term storage of data associated with the controller 200. The storage interface 208 suitably uses bulk storage, such as any suitable addressable or serial storage such as a disk, optical, tape drive, and the like, as shown as 216, as well as any suitable storage medium, as will be appreciated by one of ordinary skill in the art.

A network interface subsystem 210 suitably routes input and output from an associated network, allowing the controller 200 to communicate to other devices. The network interface subsystem 210 suitably interfaces with one or more connections with external devices to the controller 200. By way of example, illustrated is at least one network interface card 214 for data communication with fixed or wired networks such as Ethernet, token ring, and the like and a wireless interface 218 suitably adapted for wireless communication via means such as WiFi, WiMax, wireless modem, cellular network, or any suitable wireless communication system. It is to be appreciated however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2 (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality, as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that can perform one or more of the document processing operations listed above.

The engine 302 is suitably interfaced to a user interface panel 310, which panel 310 allows for a user or administrator to access functionality controlled by the engine 302. Access is suitably enabled via an interface local to the controller or remotely via a remote thin or thick client.

The engine 302 is in data communication with print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, a suitable interface is provided for network-based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter, or any suitable mechanism for interchange of an electronic document to a format better suited for interchange with device functions such as print 304, facsimile 306, or scan 308.

Finally, the job queue 312 is in data communication with a job parser 318, which job parser 318 suitably functions to receive print job language files from an external device, such as client device services 322. The client device services 322 suitably include printing, facsimile transmission, or other suitable input of an electronic document for which handling by the controller function 300 is advantageous. The job parser 318 functions to interpret a received electronic document file and relay it to the job queue 312 for handling in connection with the afore-described functionality and components.

In operation, image data encoded in a multi-dimensional color space is first received. Histogram data is then calculated from the received image data. Dominant spike regions in the calculated histogram data are then identified, and an N-sum value of the identified spike regions is calculated. A calculated N-sum value is then tested against a predetermined threshold value. Received image data is then classified as an artistic scene, a tinted artistic scene, or a sepia tone range artistic scene, in accordance with an output of the testing of the calculated N-sum value against the predetermined threshold value.

In accordance with one embodiment of the subject application, input image data is received by the controller 108 or other suitable component associated with the document processing device 104, the user device 114, or the like. As will be understood by those skilled in the art, any suitable device capable of performing image processing operations is capable of being used in accordance with the implementation of the subject application described herein. The skilled artisan will further appreciate that the receipt of input image data corresponds to image data communicated via the computer network 102, generated via operations of the document processing device 104, retrieved from a suitable storage device, or the like. It will also be appreciated by those skilled in the art that the image data is capable of being received in a variety of image formats, e.g., JPEG, TIFF, RAW, PDF, BMP, GIF, or the like. According to one embodiment of the subject application, the image data is suitably encoded in a multi-dimensional color space such as, for example and without limitation, RGB, CMYK, CIE L*a*b*, YC_{b}Cᵣ, YIQ, HSV, xyY, u′v′Y, L*u*v*, or the like.

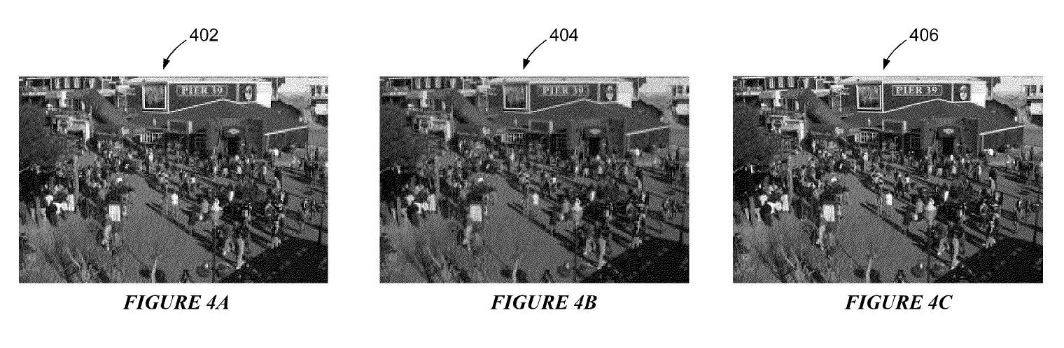

FIG. 4A illustrates an example input image 402 corresponding to a normal street scene, as will be appreciated by those skilled in the art. It will be understood by those skilled in the art that, during typical operations of an associated document processing device 104 equipped for automatic image enhancement, image attributes are capable of being mistakenly adjusted. FIG. 4B illustrates an artistically tinted image 404 corresponding to the input image 402 of FIG. 4A. The skilled artisan will appreciate that the artistically tinted image 404 represents the input image 402 after the image 402 was tinted by a suitable photographic or image editing application, e.g., PICASA or the like. FIG. 4C illustrates an erroneous, or mistaken, application of automatic image correction via the image 406. Thus, the image 406 illustrates the result of an attempt at automatic color correction, resulting in the removal of the intentionally applied artistic scene.

The controller 108 or other suitable component associated with the document processing device 104, the user device 114, or the like then down-sizes the received image data upon a determination that the image data as received would require substantial resources on the part of the processing device, e.g., the controller 108, the user device 114, etc. That is, the received input image data represents a substantially large image file, which would use a high percentage of available processing resources. The skilled artisan will appreciate that such down-sizing of image data corresponds, for example and without limitation, to the “blurring” and/or “down-sampling” of the received input image data or other reduction in the total number of pixels in an image, as will be known in the art. In addition, when the received input image data is not in a desirable format, i.e., the image data is not in HSV (hue, saturation, value (brightness)) color space, the controller 108 or other component associated with the document processing device 104, the user device 114, or the like then converts the received image data into HSV encoded image data.

Near achromatic pixels in the received input image data are then identified in accordance with the system and method described in co-pending patent application Ser. No. 12/037,711, the entirety of which is incorporated herein by reference. Those skilled in the art will appreciate that near achromatic pixels correspond to those pixels in an image having no color (achromatic) or those pixels that are almost achromatic. The near achromatic pixels identified by the controller 108 or other suitable component associated with the document processing device 104, the user device 114, or the like are then selectively discarded in accordance with the subject application. Histogram data is then calculated from the received image data following the discarding of the selected near achromatic pixels. In accordance with one embodiment of the subject application, the histogram data corresponds to a normalized histogram in hue with the selected near achromatic pixels discarded.

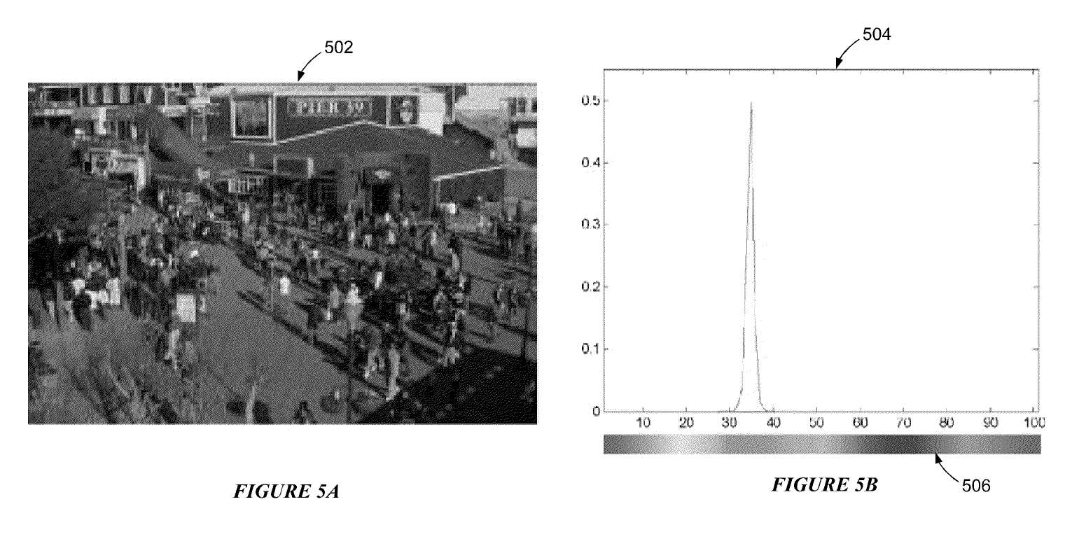

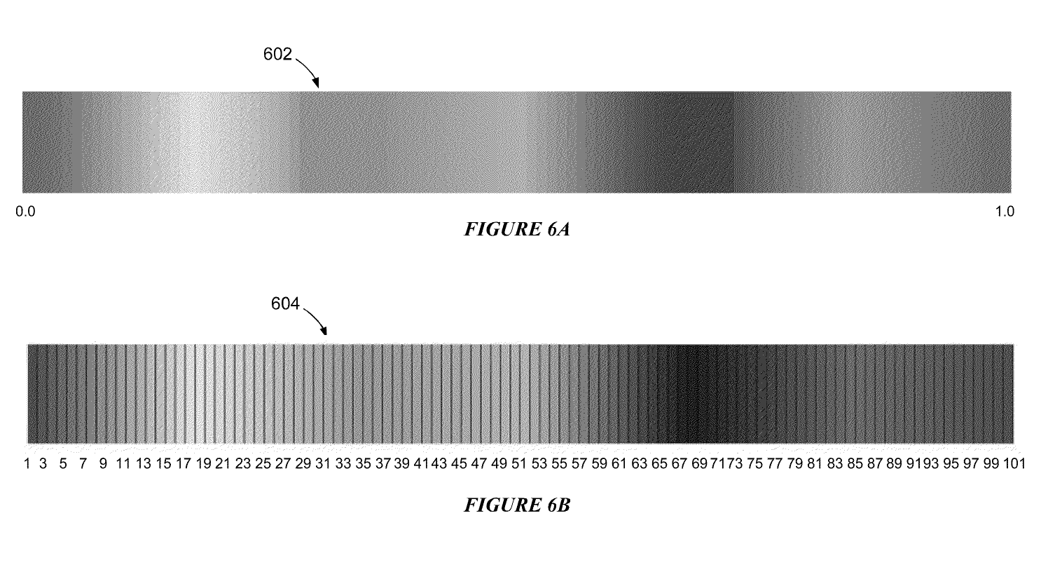

The skilled artisan will appreciate that, typically, one class of artistic scenes has a characteristic of color (hue) concentrations, i.e., the scene includes the presence of one or two dominant colors. Such presence is capable of being detected, as discussed in greater detail below, via a normalized hue histogram that is generated from a received input image. FIGS. 5A and 5B illustrate such a received input image 502 and associated normalized hue histogram 504. Thus, the hue histogram generated from the received artistic scene image 502 depicted in FIG. 5A generally has one or two “spikes” or “peaks,” as represented in the hue histogram 504 of FIG. 5B. The skilled artisan will appreciate that the hue ramp 506 associated with the hue histogram 504 of FIG. 5B indicates that there is a hue concentration, or spike, at the green color, e.g., approximately 45% of the total pixels in the image 502 are green. The skilled artisan will appreciate that additional examples of such histograms are discussed with respect to FIGS. 6A-13, referenced in greater detail below.

From the calculated histogram data, the dominant spike regions are then identified. An N-sum value of the identified spikes of the histogram data is then calculated. Use and calculation of the N-sum value is explained in greater detail with respect to FIGS. 4A-13, discussed below. The N-sum value is then tested against a predetermined threshold value to determine whether the calculated N-sum value is within a predetermined range of the threshold value. When the N-sum value does fall within the predetermined range of the threshold value, the received input image is classified as an artistic scene image, whereupon no automatic image correction is undertaken on the image by the associated controller 108 or other suitable component of the document processing device 104, the user device 114, or the like. In the event that the calculated N-sum value falls outside the predetermined range of the threshold value, the received image is classified as a non-artistic scene, and any suitable automatic image correction is capable of being performed by the associated component of the document processing device 104, the user device 114, or the like.

The foregoing will be better understood in conjunction with the example illustrations of FIGS. 6A-13, which explain but do not limit the subject system and method for artistic scene detection in accordance with the subject application. Turning now to FIGS. 6A-13, there are shown several example implementations of the subject application for artistic scene image detection. Thus, in applying the methodology discussed above, a received input image, encoded in a multi-dimensional color space, is first blurred so as to reduce aliasing and then down-sampled, if necessary, so as to increase the speed at which the image is processed via the corresponding reduction in computational costs to the document processing device 104, the user device 114, or other device implemented in accordance with the subject application.

The input image is then, after blurring and/or down-sampling, converted to HSV (hue, saturation, value (brightness)) color space. It will be understood by those skilled in the art that the input image is capable of being received in HSV color space; however, typically input image data is received in RGB or CMYK color space, thus requiring conversion to HSV color space. The histogram of the image is then calculated in hue and normalized by the total number of pixels associated with the received input image. The skilled artisan will appreciate that the hue angle in HSV is capable of being complicated when the hue angles wrap around or the hue angles are considered as noise when the pixels are achromatic or almost achromatic. FIG. 6A illustrates a hue ramp 602 wherein the hue angles wrap around. FIG. 6B depicts a hue ramp 604 marked with indices in 100 even partitions, as will be appreciated by those skilled in the art. The wrap-around of hue angles is illustrated in the hue ramp 604 of FIG. 6B such that H[i]=i=th histogram count in 100 even partitions between 0.0 and 1.0. For example, if H[1]=count at 0.0 and H[101]=count at 1.0, then H[0]=H[101], H[−1]=H[100], and H[−2]=H[99], and H[102]=H[1], H[103]=H[2] and H[104]=H[3], etc.

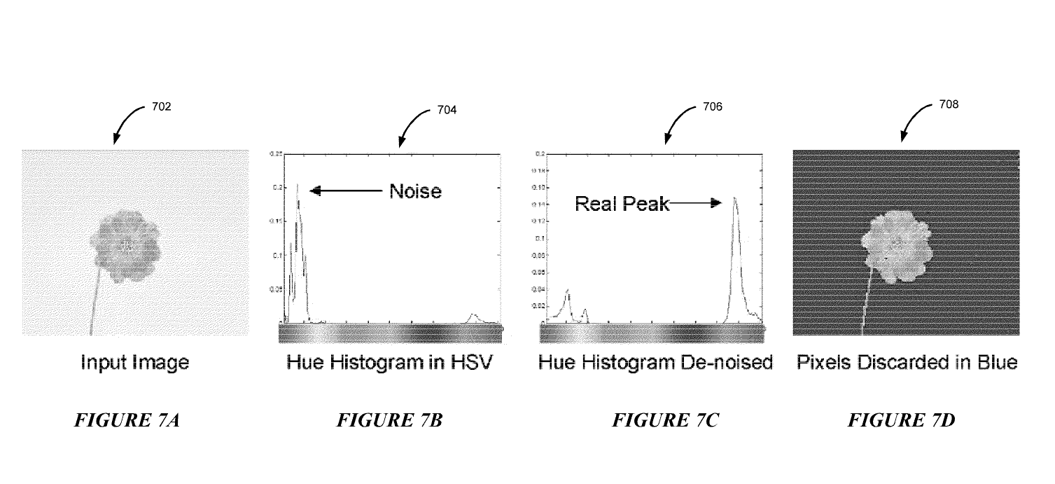

The near achromatic pixels of the input image are then identified and selectively removed. FIG. 7A illustrates an input image 702; FIG. 7B illustrates a hue histogram 704 in HSV color space corresponding to the input image 702 in which the peaks are noise; FIG. 7C illustrates a hue histogram 706 in HSV color space after near achromatic pixels have been discarded, thereby illustrating the real peaks of the input image 702; and FIG. 7D thus illustrates the discarded pixels, shown as blue in image 708, as a result of the de-noising performed in accordance with one embodiment of the subject application. Stated another way, FIGS. 7A-7D illustrate the de-noising of an input image in accordance with one embodiment of the subject application. Therefore, given an input image, the histogram in H (hue) value is calculated and normalized by the total number of pixels with all near achromatic pixels discarded. For example, a normalized histogram in hue, H[i], equals the percentage of pixels of hue value equal to i in i*360 degrees.

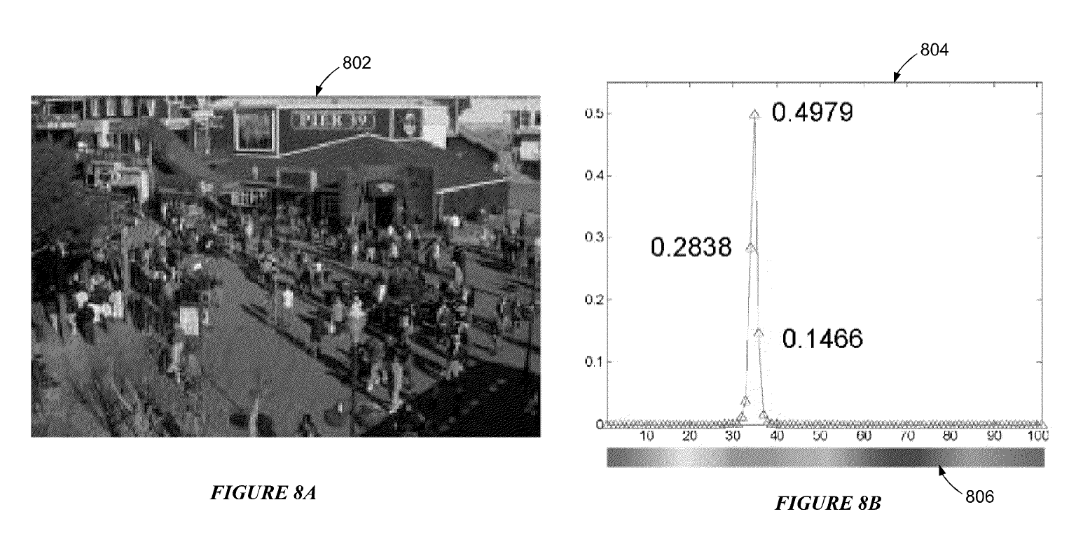

The dominant spike or peak regions of the normalized histogram in hue, with near achromatic pixels discarded, are then identified. FIG. 8A illustrates an artistic scene input image 802 and FIG. 8B illustrates a normalized histogram 804 in hue corresponding thereto. As shown, the histogram 804 includes a single spike or peak region ((e.g., H[i] at Iₘₐₓ=35), such that the maximum histogram count is expressed as Hₘₐₓ=H[Iₘₐₓ]=0.4979, i.e., after discarding near achromatic pixels, 49.79% of all the pixels remaining are with hue angle 0.36*360=129.60 degrees (shown in the hue ramp 806 as indicating the peak is green). N-sum at i is then defined to be the sum of N closest neighbors centered at i. For example, where N=3, the 3-sum at Iₘₐₓ=35 in FIGS. 8A and 8B equals the sum of H[34]=0.2838, H[35]=0.4979 and H[36]=0.1466, or 0.9283. For example and without limitation, locating or identifying of the single spike is accomplished by locating the maximum histogram count in hue, Hₘₐₓ, at Iₘₐₓ, and calculating the N-Sum at Iₘₐₓ, if N-Sum>T for some threshold T, then the input image is classified as an artistic scene, where N can be 3, 5, or 7, etc.

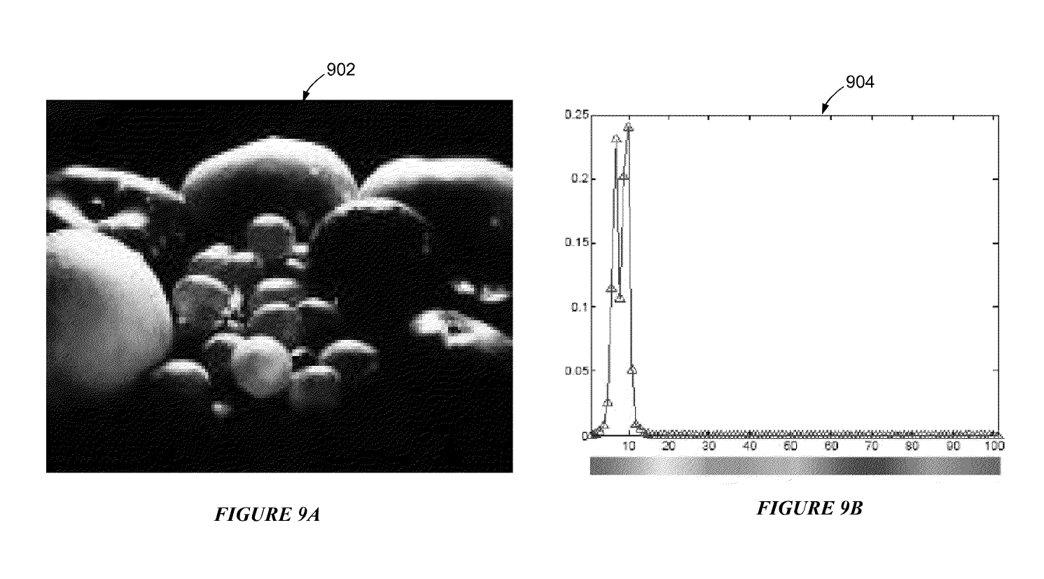

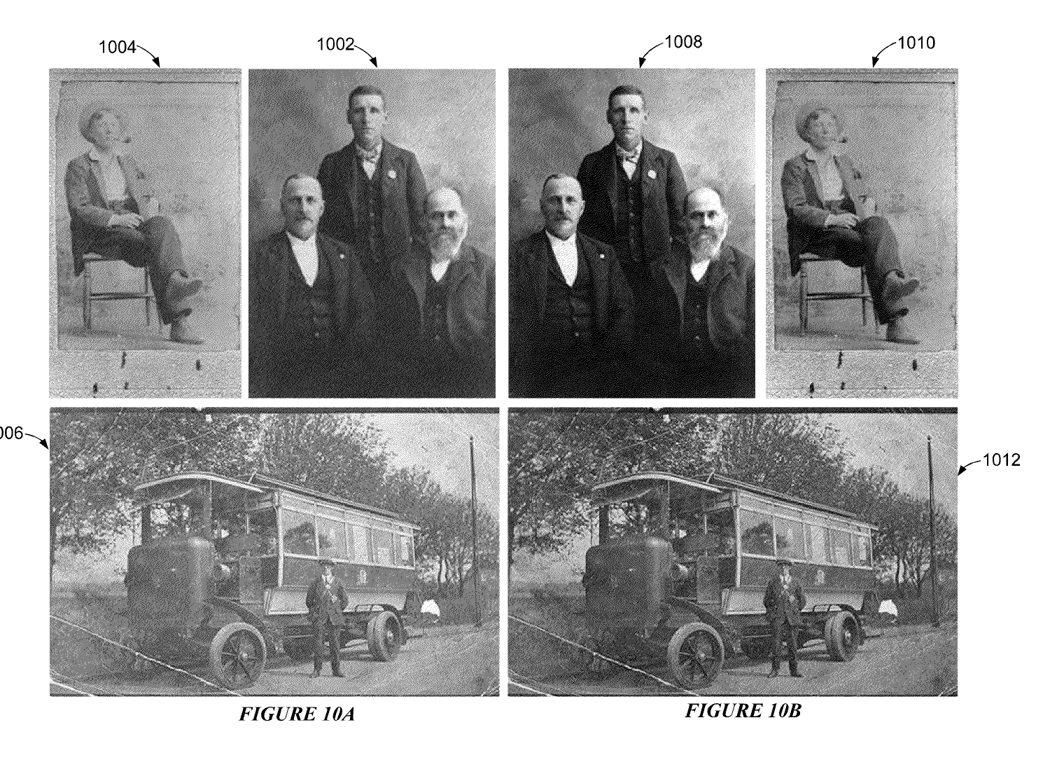

The skilled artisan will appreciate that some input images are capable of including more than a single spike or peak region. FIG. 9A illustrates an artistic input image 902 corresponding to a sepia tone image, and FIG. 9B illustrates a corresponding normalized histogram 904 in hue after near achromatic pixels are discarded. The normalized histogram 904 includes two spike or peak regions, which are illustrated in FIG. 9B. FIG. 10A depicts three images 1002, 1004, and 1006 corresponding to sepia tone input images, and FIG. 10B depicts three images 1008, 1010, and 1012 corresponding, respectively, to images 1002, 1004, and 1006, after application of an automatic color correction mechanism, such as that offered in PHOTOSHOP by Adobe Systems, Inc. The skilled artisan will appreciate that, while not shown, each of these images 1002, 1004, and 1006 have histograms with one or more spikes or peak regions.

In accordance with one embodiment of the subject application, the identification of more than one spike or peak region is accomplished via locating of all significant spikes in the image, e.g., the associated normalized histogram in hue of the image. For example, searching for all i values such that H[i−1]<H[i]>H[i+1] and H[i]>Th where Th is a pre-determined threshold value, then locating the tallest and the second tallest spikes, Hₘₐₓ=H(Iₘₐₓ) and Hₘₐₓ₂=H(Iₘₐₓ₂), and then calculating the combined N-Sum, i.e., the sum of the N-Sum's at Iₘₐₓ and Iₘₐₓ₂. Thus, if the combined N-Sum>Th′ for some threshold Th′, then the input image is classified as an artistic scene, where N is capable of equating to 3, 5, 7, or the like. It will be appreciated by those skilled in the art that, when searching for the tallest and second tallest spikes, the fact that the array H[i] wraps around must be taken into account. Furthermore, the skilled artisan will understand that attention is required to remove redundancy in the calculation of the combined N-Sum when the N-Sums of the tallest and second tallest spikes overlap, such as is illustrated in the histogram 904 of FIG. 9B.

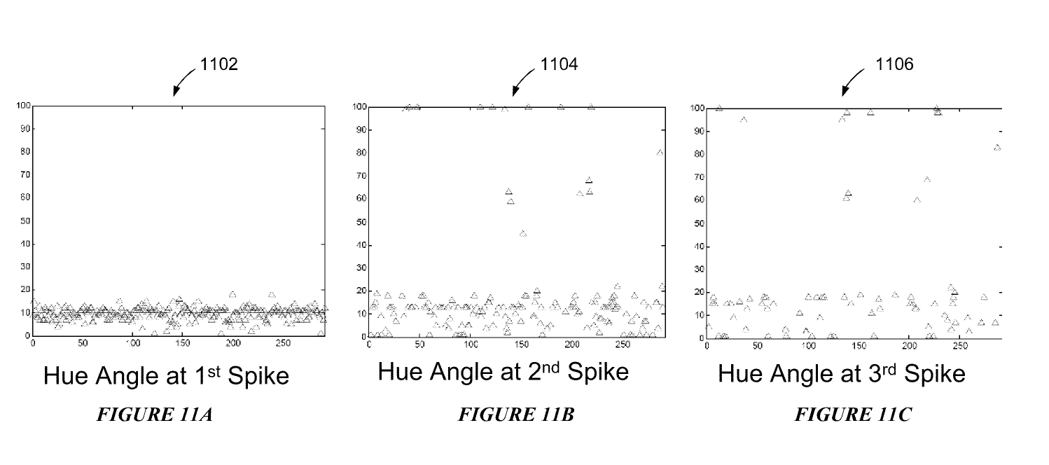

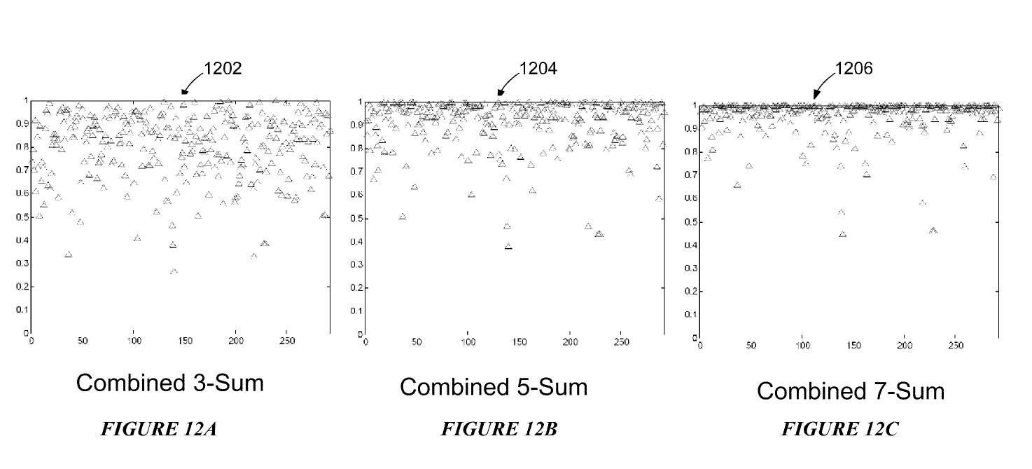

FIGS. 11A, 11B, and 11C illustrate plots 1102, 1104, and 1106 of hue angles at a first spike, a second spike, and a third spike, respectively, in accordance with a plurality of observed sepia tone images, e.g., 300 (not shown). The skilled artisan will appreciate that the plot 1102 of FIG. 11A corresponds to hue angles associated with the first spike, the plot 1104 of FIG. 11B corresponds to the hue angles associated with the second spike, and the plot 1106 of FIG. 11C corresponds to the hue angles associated with the third spike. In FIG. 11A, it is shown that the hue angles of the first spike are clustered within the range of 1 and 18, while some of the observed images do not have second spikes (FIG. 11B) and even fewer observed images have third spikes (FIG. 11C). FIG. 12A illustrates plots 1202 of the combined 3-Sum at the first and second spikes, FIG. 12B illustrates plots 1204 of the combined 5-Sum at the first and second spikes, and FIG. 12C illustrates plots 1206 of the combined 7-Sum at the first and second spikes. The skilled artisan will thereby appreciate that, for the majority of the observed images, the combined 7-Sum is above 0.9.

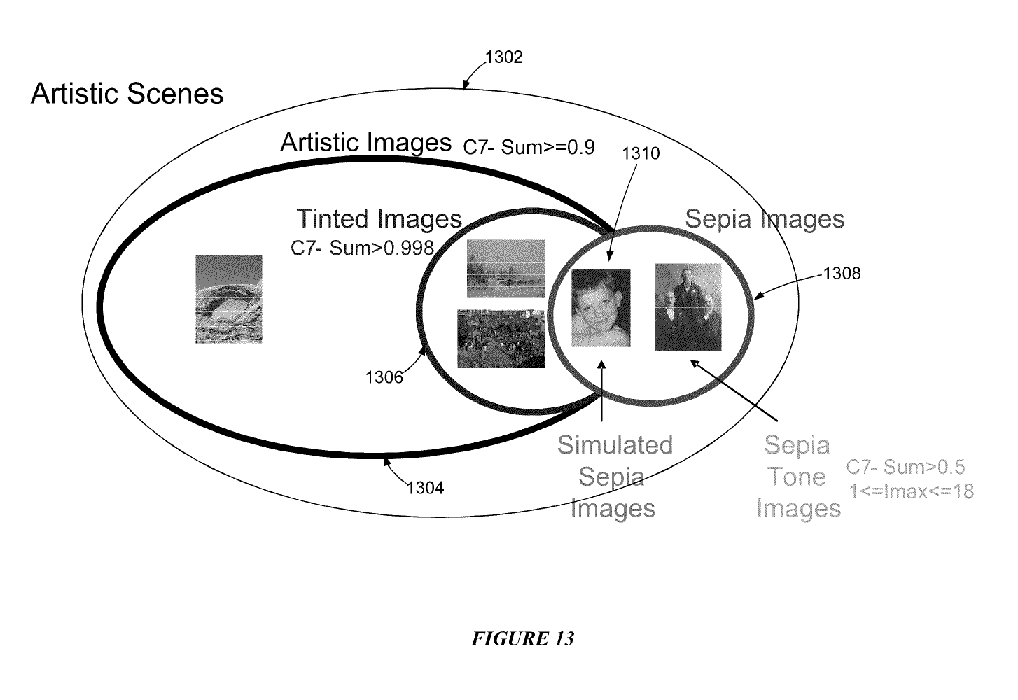

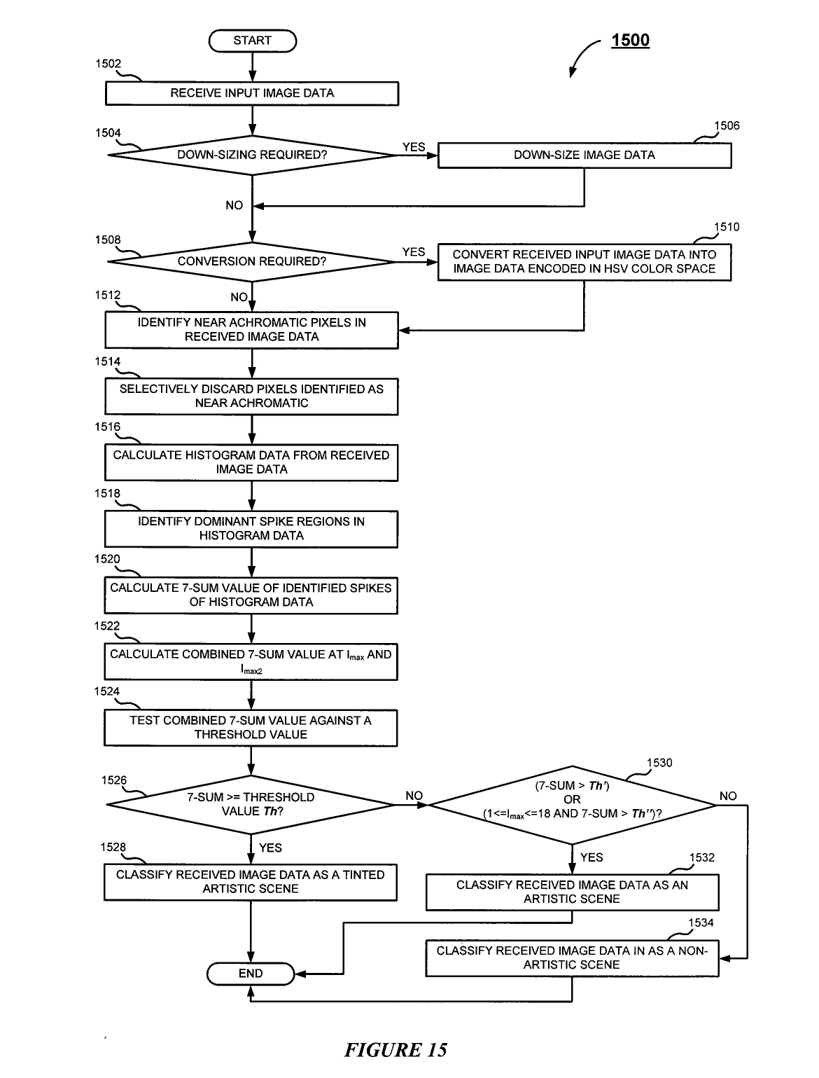

FIG. 13 shows several types of artistic scenes 1302 and the various relationships between the types. As depicted in FIG. 13, the set of artistic scenes 1302 includes the set of artistic images 1304 and the set of sepia images 1308. The artistic images 1304, as illustrated in FIG. 13, is a superset of tinted images 1306, and the intersection of tinted images 1306 and sepia images 1308 is represented as the set of simulated sepia images 1310, e.g., sepia images generated by suitable photographic or image processing applications, e.g., PICASA. The skilled artisan will appreciate that, for the foregoing images and applications of the subject application, the threshold values referenced therein are capable of adjustment in accordance with the applications to which they are applied. For purposes of the analysis above, the threshold values have been optimized for automatic white balance and white stretch (image correction), with T=0.0005, Th=0.998, Th′=0.9 and Th″=0.5 (used in the description of FIG. 15, discussed in greater detail below).

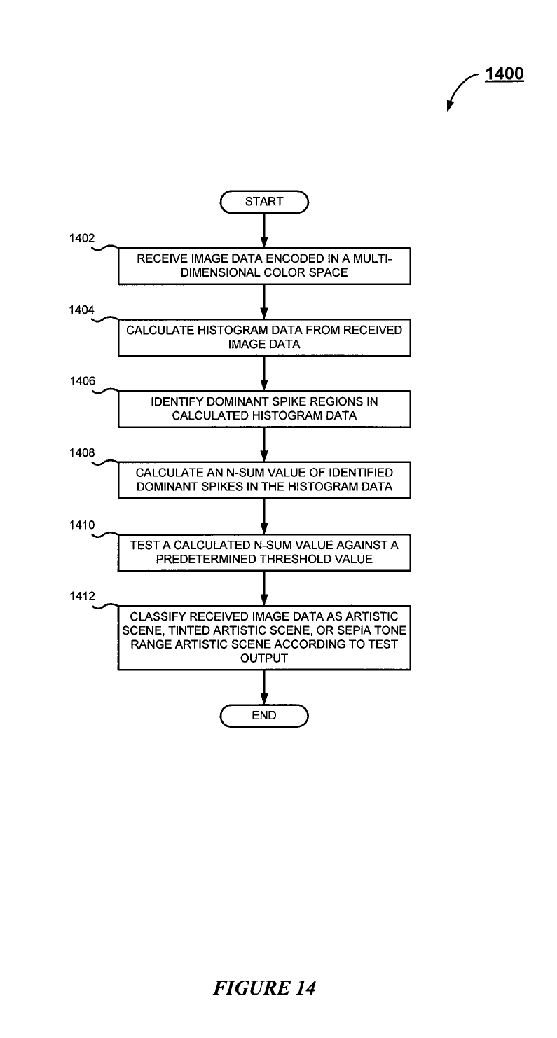

The skilled artisan will appreciate that the subject system 100 and components described above with respect to FIGS. 1-13 will be better understood in conjunction with the methodologies described hereinafter with respect to FIG. 14 and FIG. 15. Turning now to FIG. 14, there is shown a flowchart 1400 illustrating a method for artistic scene image detection in accordance with one embodiment of the subject application. Beginning at step 1402, image data, encoded in a multi-dimensional color space, is received. It will be appreciated by those skilled in the art that the multi-dimensional color space is representative of any of the myriad various color spaces associated with image processing in accordance with the subject application including, for example and without limitation, CIE L*a*b*, YC_{b}Cᵣ, YIQ, xyY, u′v′Y, L*u*v*, RGB, CMYK, HSV, or the like. Those skilled in the art with also appreciate that the received image data is capable of being received in a variety of image formats, e.g., JPEG, TIFF, RAW, PDF, BMP, GIF, or the like.

At step 1404, histogram data is calculated from the received image data. In accordance with one embodiment of the subject application, the histogram data is normalized by the number of pixels, as will be appreciated by those skilled in the art. The dominant spike regions of the calculated histogram data are then identified at step 1406 by the controller 108 or other suitable component associated with the document processing device 104, the user device 114, or the like. An N-sum value of the identified dominant spike regions is then calculated at step 1408. The calculated N-sum value of the identified spike regions is then tested at step 1410 against a predetermined threshold value. Suitable examples of such a predetermined threshold value are discussed in greater detail above. The controller 108 or other suitable component associated with the document processing device 104, the user device 114, or the like then classifies the received image data at step 1412 as an artistic scene, a tinted artistic scene, or a sepia tone range artistic scene in accordance with the output of the testing performed at step 1410.

Referring now to FIG. 15, there is shown a flowchart 1500 illustrating a method for artistic scene image detection in accordance with one embodiment of the subject application. FIG. 15 is included herein for illustration and example purposes only, particularly with the selection of the 7-Sum determined value, and the skilled artisan will appreciate that other selected N-Sum values are capable of being used in accordance with the example method of FIG. 14. The methodology of FIG. 15 begins at step 1502, whereupon input image data such as a digital photograph, image, or the like is received by the controller 108 or other suitable component associated with the document processing device 104, the user device 114, or the like. It will be appreciated by those skilled in the art that the input image data is capable of being received from the user device 114 by the document processing device 104 via the computer network 102 from a portable storage device accessed by the document processing device 104 or the user device 114; via electronic communication to the document processing device 104 or the user device 114; via operations of the document processing device 104, e.g., scanning, facsimile, etc.; or other means, as will be known in the art. Preferably, the received input image data is received as data encoded in a multi-dimensional color space such as, for example and without limitation, RGB, CMYK, CIE L*a*b*, YC_{b}Cᵣ, YIQ, HSV, xyY, u′v′Y, L*u*v*, or the like. In accordance with one embodiment of the subject application, the input image data is capable of being received in any of a plurality of different electronic formats, as will be understood by those skilled in the art. Suitable examples of such formats include, for example and without limitation, JPEG, TIFF, RAW, PDF, BMP, GIF, or the like.

A determination is then made at step 1504 whether down-sizing of the received input image data is required. The skilled artisan will appreciate that such a determination is made by the controller 108 or other suitable component associated with the document processing device 104, the user device 114, or the like, based upon the computational costs associated with processing the received input image in accordance with the subject methodology of FIG. 15. Thus, when the received input image data corresponds to a large image file, e.g., high resolution, size, or the like, the controller 108 or other suitable component associated with the document processing device 104, the user device 114, or other such device then down-sizes the received input image file. Upon such a determination that down-sizing is required, flow proceeds to step 1506. At step 1506, the received image data is down-sized, as will be appreciated by those skilled in the art. Preferably, the down-sizing of image data corresponds, for example and without limitation, to the “blurring” and/or “down-sampling” of the received input image data.

Following down-sizing of the received image data or upon a determination that no down-sizing is required, flow progresses to step 1508. At step 1508, a determination is made by the controller 108 or other suitable component associated with the document processing device 104, the user device 114, or the like as to whether the received input image data requires conversion to HSV (hue, saturation, value (brightness)) color space. The skilled artisan will appreciate that, while the image data is capable of being received encoded in HSV color space, typical digital images are received in RGB or CMYK color space and, thus, require conversion in accordance with the subject application. Thus, when conversion is determined to be required, flow proceeds to step 1510, whereupon the received input image data is converted to image data encoded in HSV color space.

Once HSV encoded image data has been obtained, operations proceed to step 1512, whereupon near achromatic pixels in the received input image data are identified. The identified near achromatic pixels are then selectively discarded by the controller 108 or other suitable component associated with the document processing device 104, the user device 114, or the like at step 1514. Those skilled in the art will appreciate that near achromatic pixels correspond to those pixels in an image having no color (achromatic) or those pixels that are almost achromatic. The identification and selective discarding of such near achromatic pixels are more adequately described in co-pending patent application Ser. No. 12/037,711, as referenced above.

At step 1516, histogram data is calculated from the image data encoded in HSV color space. In accordance with one embodiment of the subject application, the histogram data is normalized in hue based upon the total number of pixels with all near achromatic pixels discarded. Dominant spike or peak regions are then identified from the calculated histogram data at step 1518. The 7-Sum value of identified spikes or peaks in the histogram data is then calculated by the controller 108 or other suitable component associated with the document processing device 104, the user device 114, or the like at step 1520. The use and calculation of the 7-Sum values associated with various spikes in the histogram data is addressed in greater detail above with respect to FIGS. 4A-13.

At step 1522, the combined 7-Sum for the received image is then calculated at Iₘₐₓ and Iₘₐₓ₂. The calculated combined 7-Sum value is then tested at step 1524 against a predetermined threshold value Th. In accordance with one example embodiment, the threshold values are optimized for automatic white balance and white stretch, i.e. fine-tuned in accordance with selected applications, such that the threshold value Th is 0.998, the threshold value Th′ is 0.9, and the threshold value Th″ is 0.5. A determination is then made at step 1526 as to whether the combined 7-Sum value falls within a pre-determined range of the threshold value, i.e. whether the combined 7-Sum value is greater than or equal to the threshold value Th. When the combined 7-Sum value is greater than or equal to the threshold value Th, flow proceeds to step 1528, whereupon the received input image is classified as a tinted artistic scene image. Thus, it will be apparent to those skilled in the art that no automatic image correction is undertaken on the image by the associated controller 108 or other suitable component of the document processing device 104, the user device 114, or the like. Upon a determination at step 1526 that the calculated combined 7-sum value is not greater than or equal to the threshold value Th, flow proceeds to step 1530. At step 1530, a determination is made as to whether the combined 7-sum value is greater than a threshold value Th′, or whether the Iₘₐₓ value is greater than or equal to 1 but less than or equal to 18 (sepia (skin) tone range) and the combined 7-sum value is greater than a threshold value Th″. Upon a negative determination at step 1530, flow proceeds to step 1534, whereupon the received image is classified as a non-artistic scene, resulting in the performance of any suitable automatic image correction applicable to the received image data by the associated component of the document processing device 104, the user device 114, or the like. Upon a positive determination at step 1530, flow proceeds to step 1532, whereupon the received image data is classified as an artistic scene and, thus, no automatic image correction is undertaken on the received image by the user device 114, the controller 108, or other such component associated with the document processing device 104.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program: for example, a storage medium such as ROM or RAM; optical recording media such as CD-ROM or magnetic recording media such as floppy discs; or any transmissible carrier such as an electrical or optical signal conveyed by electrical or optical cable, radio, or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. An artistic scene image detection system comprising:
means adapted for receiving image data encoded in a multi-dimensional color space;
means adapted for calculating histogram data from received image data;
means adapted for identifying dominant spike regions in the calculated histogram data;
means adapted for calculating an N-sum value of identified dominant spikes in the histogram data;
testing means adapted for testing a calculated N-sum value against a predetermined threshold value; and
classifying means adapted for classifying received image data as at least one of an artistic scene, a tinted artistic scene, and a sepia tone range artistic scene in accordance with an output of the testing means.

2. The system of claim 1 further comprising:
means adapted for identifying near achromatic pixels in received image data; and
means adapted for selectively discarding identified near achromatic pixels prior to calculation of histogram data therefrom.

3. The system of claim 1 further comprising:
means adapted for receiving input image data; and
means adapted for converting received input image data into the image data encoded in HSV color space.

4. The system of claim 1 further comprising means adapted for down-sizing image data prior to calculation of histogram data therefrom.

5. A method for artistic scene image detection comprising the steps of:
receiving image data encoded in a multi-dimensional color space;
calculating histogram data from received image data;
identifying dominant spike regions in the calculated histogram data;
calculating an N-sum value of identified dominant spikes in the histogram data;
testing a calculated N-sum value against a predetermined threshold value; and
classifying received image data as at least one of an artistic scene, a tinted artistic scene, and a sepia tone range artistic scene in accordance with an output of the testing step.

6. The method of claim 5 further comprising the steps of:
identifying near achromatic pixels in received image data; and
selectively discarding identified near achromatic pixels prior to calculation of histogram data therefrom.

7. The method of claim 5 further comprising the steps of:
receiving input image data; and
converting received input image data into the image data encoded in HSV color space.

8. The method of claim 5 further comprising the step of down-sizing image data prior to calculation of histogram data therefrom.

9. A computer-implemented method for artistic scene image detection comprising the steps of:
receiving image data encoded in a multi-dimensional color space;
calculating histogram data from received image data;
identifying dominant spike regions in the calculated histogram data;
calculating an N-sum value of identified dominant spikes in the histogram data;
testing a calculated N-sum value against a predetermined threshold value; and
classifying received image data as at least one of an artistic scene, a tinted artistic scene, and a sepia tone range artistic scene in accordance with an output of the testing step.

10. The computer-implemented method of claim 9 further comprising the steps of:
identifying near achromatic pixels in received image data; and
selectively discarding identified near achromatic pixels prior to calculation of histogram data therefrom.

11. The computer-implemented method of claim 9 further comprising the steps of:
receiving input image data; and
converting received input image data into the image data encoded in HSV color space.

12. The computer-implemented method of claim 9 further comprising the step of down-sizing image data prior to calculation of histogram data therefrom.
